(19) United States
(12) Patent Application Publication
(10) Pub. No.: US 2004/0095909 A1
(43) Pub. Date: May 20, 2004

(54) Method of and apparatus for amplitude tracking and automatic frequency correction of a time-division multiple-access channel

(76) Inventor: Shousheng He, Sodra Sandby (SE)

Correspondence Address: JENKENS & GILCHRIST, 3200 Fountain Place, 1445 Ross Avenue, Dallas, TX, 75202-2799, US

(21) Appl. No.: 10/300,038

(22) Filed: Nov. 19, 2002

(51) Int. Cl. H04B 7/212

(52) U.S. Cl. 370/337; 370/347

(57) ABSTRACT

An apparatus and method enhance equalizer performance in multipath fast-fading channels in systems such as those employing GSM EDGE. The enhancement is achieved via computationally-efficient envelope-fade tracking that tracks a collective amplitude variation of a multipath channel. The envelope-fade tracking can be used in combination with an Automatic Frequency Compensation (AFC) phase tracker. Parameters, such as the order and the step size of the envelope fade tracker and the AFC, can be optimized independently.

### BACKGROUND OF THE INVENTION

1. Technical Field of the Invention

The present invention relates in general to amplitude tracking of a channel and, more particularly, to amplitude tracking and automatic frequency correction of a time-division multiple-access channel

2. Description of Related Art

In digital time-division multiple-access (TDMA) communication systems, such as, for example, Global System for Mobile Communications (GSM), Enhanced Data for GSM Evolution (EDGE), and Digital Advanced Mobile Phone Service (DAMPS), an equalizer at a receiver is necessary in order to compensate for Inter-Symbol-Interferences (ISI) and other distortions, such as those due to transmitter pulse shaping and multi-path signal propagation. Equalizer settings are based on channel estimates obtained by measurement of a channel response via a known training sequence that is embedded in a transmission burst. The training sequence is located, for example, at a burst mid-ample, as in EDGE. When a mobile station is moving fast, in addition to a Doppler frequency shift, each path in a multipath propagation channel experiences fast random variations, which are typically referred to as fast fading. In a fast-fading environment, channel parameters drift gradually away from a channel estimate obtained during equalization. The channel-parameter drift often causes significant, and unacceptable, performance degradation.

A relatively-small frequency offset almost always exists, even after Frequency Correction Channel (FCCH) acquisition between a transmitter and a receiver that are stationary relative to one another. This frequency offset is due to, among other things, component deviation, temperature variation, and local-oscillator phase jitters. An Automatic Frequency Correction (AFC) mechanism is often required in baseband processing to compensate for this frequency offset. Channel tracking and AFC are often treated separately. For AFC, a second-order Phase Locked Loops (PLL) approach is common. A decision-directed adaptation, such one using a Kalman filter or Least Mean Square (LMS) filter, is typically employed for state updating.

Channel tracking in a multipath environment can be very complex. This is primarily because perfect channel tracking requires updating not only all channel taps, each of which is a complex variable, but also requires updating of coefficients of the pre-filter, which is also referred to as a whitened matched filter, before the equalizer In order to avoid prohibitive complexity, extensive efforts have been undertaken to develop practical algorithms to improve tracking performance.

Complex-envelope tracking can be used to attempt to achieve a compromise between performance and complexity. A limitation of complex-envelope tracking is that phase distortion can be tracked only to a very limited degree. This limitation is primarily due to a non-linear relationship between phase shift and complex-envelope observation. A complex-envelope tracker that alters both amplitude and phase of the channel model conflicts with the phase adjustment provided by the AFC; therefore, an AFC mechanism cannot be effectively employed in parallel with the complex-envelope tracker. Performance losses due to this limitation of complex-envelope tracking can be significant in high-carrier-frequency cases (e g., 1800 MHz in EDGE) and when a frequency offset exists. In addition, hardware implementations of the equalizer are more complex when adjustments are applied to the channel model and thereby cause the channel model to change on a symbol-by-symbol basis. Therefore, a method of and apparatus for amplitude tracking and automatic frequency correction of a time-division multiple-access channel that eliminates the drawbacks mentioned above and other drawbacks is needed.

### SUMMARY OF THE INVENTION

These and other drawbacks are overcome by embodiments of the present invention, which provides a method of and apparatus for amplitude tracking and automatic frequency correction of a time-division multiple-access channel. In an embodiment of the present invention, a channel-tracking apparatus for use in a time-division multiple-access system includes an amplitude tracker and an automatic frequency correction (AFC) mechanism. The amplitude tracker is adapted to track a collective magnitude variation of a channel. The AFC mechanism is adapted to track phase variations of the channel, including phase variations caused by both channel fade and frequency offset between a transmitter and a receiver. In another embodiment of the present invention, a method of channel tracking in a time-division multiple-access system includes obtaining a composite channel and tracking a collective magnitude variation of the composite channel. A phase variation of the composite channel is tracked and a sequence estimate of the channel is obtained via the collective magnitude variation and the phase variation of the composite channel.

### BRIEF DESCRIPTION OF THE DRAWINGS

A more complete understanding of exemplary embodiments of the present invention can be achieved by reference to the following Detailed Description of Exemplary Embodiments of the Invention when taken in conjunction with the accompanying Drawing, wherein:

FIG. 1 is a block diagram of an equalizer 100 in accordance with the principals of the present invention.

### DETAILED DESCRIPTION OF EXEMPLARY EMBODIMENTS OF THE INVENTION

Embodiments of the present invention track the overall amplitude of a fading channel without disturbing the phase of the channel. In an embodiment of the present invention, a PLL-type AFC is used in conjunction with an amplitude tracker in order to make necessary adjustments to a complex baseband signal.

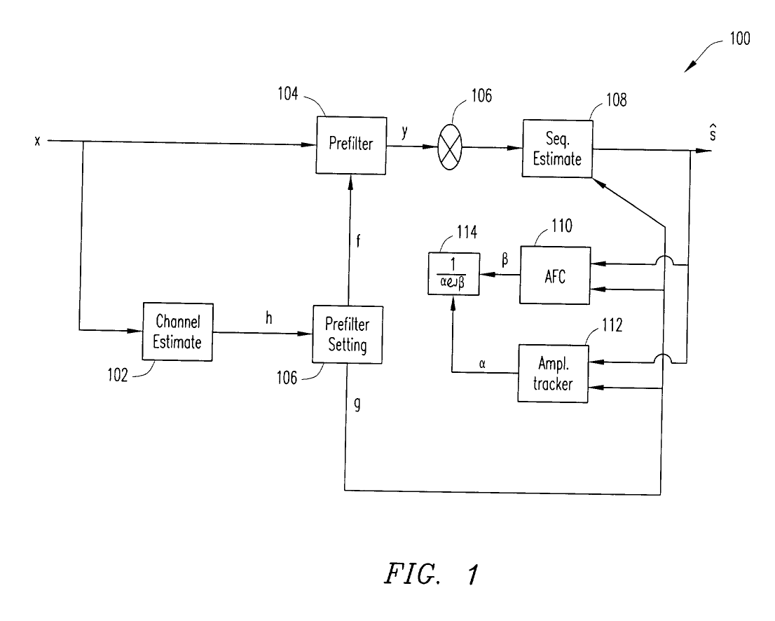

FIG. 1 is a block diagram of an equalizer 100 in accordance with principles of the present invention. In an embodiment of the present invention, phase and amplitude adjustments are combined before application to a received signal. As use of an AFC is well known, amplitude tracking in accordance with teachings of the present invention will be described in detail without corresponding details of the AFC being described. A received signal x is input to a channel estimate block 102 and to a pre-filter block 104. An estimated channel model h is output by the channel estimate block 102 to a pre-filter setting block 106. At the pre-filter setting block 106, an M-tap composite channel g is obtained by convolving the estimated channel model h with pre-filter settings f generated by the pre-filter setting block 106. The pre-filter settings f are also provided to the pre-filter block 104. The pre-filter block 104 is adapted to match the received signal x in order to increase a decision point signal-to-noise ratio. After filtering of the received signal x, the pre-filter block 104 outputs a filtered received signal y.

The M-tap composite channel g is output by the pre-filter setting block 106 to a sequence estimate block 108, an AFC block 110, and an amplitude tracker block 112. The amplitude tracker scales the M-tap composite channel by an amplitude-adjustment factor α The AFC block 110 adjusts the phase of the M-tap composite channel by a phase-adjustment factor β.

The AFC block 110 and the amplitude tracker block 112 each provide their respective outputs to a complex-multiplier block 114. The complex-multiplier block 114 combines the outputs from the AFC block and the amplitude tracker block 112 and performs a symbol-by-symbol adjustment of the combined signal. For example, if the combined signal is found to be growing larger and rotating in a right-hand direction (i.e., both α and β are greater than zero), the complex-multiplier block 114 scales down the combined signal and rotates the combined signal in a left-hand direction.

The respective outputs of the pre-filter block 104 and the complex-multiplier block 114 are input to a multiplier block 116. The multiplier block 116 applies the filtered received signal y to the output of the complex-multiplier block 114 and output the result thereof to the sequence estimator block 108. The sequence estimator block 108 calculates an estimated signal ŝ, which is fed to the AFC block 110 and the amplitude tracker block 112 as shown in FIG. 1.

In accordance with teachings of the present invention, amplitude tracking performed via the amplitude tracking block 112 involves application of a real scaling factor α>0 to the complex envelope of a signal in order to minimize an average error. While different approaches can be employed without departing from the teachings of the present invention, an embodiment of the present invention that utilizes a first-order Kalman filter approach will be described in more detail below.

A message model and an observation model for amplitude tracking can be stated as:

αₙ₊₁=αₙ+εₙ (1)

yₙ=αₙzₙ+eₙ (2)

wherein alpha is the amplitude-adjustment factor of FIG. 1, beta is the phase-adjustment factor of FIG. 1, z represents a predicted signal, and s represents a transmitted signal, such that

$${Z}_{N} = {\sum }_{i = 0}^{M - 1} {g}_{i} {s}_{n - i} . \qquad ( 3 )$$

εₙ and eₙ represent noise in the message model and observation model, respectively. αₙ₊₁ and αₙ represent amplitude variations from symbol to symbol. The message model, which is also called a state-space model, models the time dependency of a user-defined state of a system. The observation model records what can be observed (i.e., measured) of the system.

The Kalman filter prediction for the amplitude tracking can be derived as follows:

$$\begin{matrix}{\hat{α}}_{n + 1} = ( \frac{{σ}_{e}^{2} + {p}_{n} \vert {z}_{n}^{*} y \vert}{{σ}_{e}^{2} + {p}_{n} {z}_{n}^{2}} ) {\hat{α}}_{n} \\ and & ( 4 ) \\ {p}_{n + 1} = \frac{{σ}_{e}^{2}}{{σ}_{e}^{2} + {p}_{n} {z}_{n}^{2}} + {σ}_{ϵ}^{2} & ( 5 )\end{matrix}$$

wherein |zₙ^{*}y| takes the amplitude of the complex operand. In practice, especially in high signal-to-noise (SNR) regions, the value of |zₙ^{*}y| is dominated by the real part thereof; therefore, |zₙ^{*}y| can typically be replaced by Re(zₙ^{*}y)without significant performance losses.

A noise sample can be estimated by comparing the expected signal and the received signal. Noise power can be estimated by averaging noise sample energy. If it is assumed that the noise variance in Equations (4) and (5) is the same for the message model and the observation model, a noise power estimate can be made, such that

σ²=σₑ²Ε(eₙeₙ^{*})=σ₆₈=Ε(εₙεₙ^{*}).

Equations (4) and (5) describe one-step prediction-based amplitude tracking. However, due to the nature of Maximum Likelihood Sequence Estimation (MSLE), a greater than one-step decision delay is often required (e g, a k-step decision delay, wherein k is an integer greater than one). The sequence estimator block 108 requires a sequence of symbols to make a reliable estimation. However, if a long sequence is used in the sequence estimator block 108, a longer decision delay is implied.

In a time-varying system, the channel x may have changed during this delay, which change could invalidate the parameters in the channel model. Thus, a careful trade-off must be made between performance and complexity. A delay of three symbols is typically a good choice in GSM when a mobile station is traveling at less than or equal to 250 km/hr. When a k-step decision delay is needed, Equations (4) and (5) are modified to read as follows:

$$\begin{matrix}{\hat{α}}_{n + 1} = \frac{{σ}^{2} {\hat{α}}_{n} + {p}_{n} {\hat{α}}_{n - k} Re ( {z}_{n}^{*} y )}{{σ}^{2} + {p}_{n} {z}_{n}^{2}} & ( 6 ) \\ {p}_{n + 1} = \frac{{σ}^{2}}{{σ}^{2} + {p}_{n} {z}_{n}^{2}} + {σ}^{2} & ( 7 )\end{matrix}$$

Embodiments of the present invention provide robust performance and computational simplicity and perform well in a pure fading environment having a relatively-low carrier frequency. When conditions change, such as, for example, when the carrier frequency is high or when a frequency offset exists, embodiments of the present invention are more adaptable. Moreover, embodiments of the present invention tend to perform better in regions with a high SNR Since system evolution is typically toward higher carrier frequency, and certain frequency offsets are almost invariably present, embodiments of the present invention are expected to provide much better performance with reasonable computational complexity.

In embodiments of the present invention, phase tracking and amplitude tracking can be adjusted individually, depending upon performance and complexity requirements. For example, a combination of a second-order amplitude tracker and a second-order phase tracker works well but with a greater complexity than the first-order amplitude tracker and second-order phase tracker described above. The combination of a first-order amplitude tracker and a second-order phase tracker, as described above, performs nearly as well and is thus a good trade-off between complexity and performance in many situations. The flexibility provided by embodiments of the present invention does not exist in current complex-envelope trackers. Finally, adjustment of the received signal after pre-filtering is easier in a hardware implementation, since the channel taps are kept constant. In addition to Kalman-based approaches, least square error prediction, including many recursive variations, can also be employed in accordance with teachings of the present invention.

Although embodiment(s) of the present invention have been illustrated in the accompanying Drawings and described in the foregoing Detailed Description, it will be understood that the present invention is not limited to the embodiment(s) disclosed, but is capable of numerous rearrangements, modifications, and substitutions without departing from the invention defined by the following claims.

What is claimed is:

1. A channel-tracking apparatus for use in a time-division multiple-access system, the apparatus comprising:
an amplitude tracker adapted to track a collective magnitude variation of a channel; and
an automatic frequency correction (AFC) mechanism adapted to track a phase variation of the channel.

2. The apparatus of claim 1, wherein the phase variation is due to at least one of a channel fade and frequency offset.

3. The apparatus of claim 1, wherein the amplitude tracker is adapted to be applied to a received signal.

4. The apparatus of claim 1, wherein the amplitude tracker is adapted to be adjusted for a plurality of decision delays

5. The apparatus of claim 1, wherein an order and at least one parameter of at least one of the amplitude tracker and the AFC mechanism can be independently adjusted.

6. The apparatus of claim 1, further comprising:
a pre-filter adapted to match the channel in order to increase a decision point signal-to-noise ratio;
a channel-estimate block adapted to receive a training sequence embedded in the channel and output an estimated channel model; and
a pre-filter setting block adapted to generate at least one prefilter setting from the estimated channel model and convolve the estimated channel model with the at least one pre-filter setting, thereby yielding a composite channel.

7. The apparatus of claim 1, further comprising a complex-multiplier block adapted to adjust a phase and a magnitude of a received signal by a combined signal, the combined signal comprising:
an output of the AFC mechanism; and
an output of the amplitude tracker.

8. The apparatus of claim 1, wherein the composite channel comprises a plurality of taps.

9. The apparatus of claim 1, wherein the amplitude tracker employs a k-step decision delay, wherein k is greater than one.

10. A method of channel tracking in a time-division multiple-access system, the method comprising:
obtaining a composite channel;
tracking a collective magnitude variation of the composite channel,
tracking a phase variation of the composite channel; and
obtaining a sequence estimate of the channel via the collective magnitude variation and the phase variation of the composite channel.

11. The method of claim 10, further comprising:
receiving a signal;
obtaining a channel estimate of the received signal, thereby yielding an estimated channel model; and
convolving the estimated channel model and at least one pre-filter setting, thereby yielding the composite channel.

12. The method of claim 11, further comprising pre-filtering the received signal.

13. The method of claim 10, further comprising adjusting the received signal with a plurality of decision delays.

14. The method of claim 10, further comprising scaling and phase adjusting of the received signal by a combined signal, wherein the combined signal comprises the phase variation and the collective magnitude variation of the composite channel

15. The method of claim 14, further comprising:
a) multiplying the scaled-and-phase-adjusted signal and a pre-filtered version of a received signal;
b) performing a sequence estimation of the signal yielded via step a) above.

16. The method of claim 10, wherein the composite channel comprises a plurality of taps.

17. The method of claim 10, wherein the step of tracking a collective magnitude variation of the composite channel comprises a k step decision delay, wherein k is greater than one.

18. The method of claim 10, wherein the steps are performed in the order listed.
